(19) United States
(12) Patent Application Publication
(10) Pub. No.: US 2017/0070979 A1
(43) Pub. Date: Mar. 9, 2017

(54) ADAPTIVE OUTER LOOP FOR PHYSICAL DOWNLINK CHANNEL LINK ADAPTATION

(71) Applicant: Telefonaktiebolaget LM Ericsson (Publ), Stockholm (SE)

(72) Inventors: Alireza MIRZAEE, Ottawa (CA); Ahmed NOUAH, Ottawa (CA)

(21) Appl. No.: 15/122,581

(22) PCT Filed: Mar. 21, 2014
(86) PCT No.: PCT/IB2014/060043

§ 371 Date: Aug. 30, 2016

(51) Int. Cl. H04W 72/04; H04L 1/18; H04L 5/00; H04W 76/04; H04W 72/14

(52) U.S. Cl. CPC H04W 72/042; H04W 76/048; H04W 72/14; H04W 72/0413; H04L 5/0055; H04L 1/1822

(57) ABSTRACT

A method and node for adjusting an outer loop for link adaptation of downlink channels, such as Physical Downlink Control Channel (PDCCH) and Physical Downlink Shared Channel (PDSCH), in a communication network to establish a control channel element aggregation level is provided. A period of time between receipt of two consecutive channel events from a user equipment, UE, is determined by a base station. At least one of an upward step and a downward step of an outer loop adjustment is adjusted based on the determined period of time, the adjusted at least one of the upward step size and downward step size affecting the outer loop adjustment for link adaptation of the downlink channel.

### TECHNICAL FIELD

The present invention relates to wireless communication, and in particular, to methods and devices for outer loop adjustment for wireless communication link adaptation.

### BACKGROUND

Growing capacity demand is challenging for wireless communication network providers. Optimizing usage of limited radio resources is a key element to satisfy this demand, which has grown exponentially over the last ten years, driven particularly by the popularity of smart phones. To meet this growing demand, new generations of wireless standards with both multiple input and multiple output (MIMO) and orthogonal frequency division multiple access (OFDMA), and/or single carrier FMDA (SC-FDMA) technologies have been developed, such as 3rd Generation Partnership Program (3GPP) Long Term Evolution (LTE) and World-Wide Interoperability for Microwave Access (WIMAX). One area of focus is the ever growing capacity demand of the network based on these standards. One of the challenges in supporting capacity growth is the optimal usage of the limited radio resources shared by User Equipments (UEs), such as Physical Downlink Control Channel (PDCCH) usage.

Some resource elements in the PDCCH region are reserved for the control information, which are Control Channel Elements (CCEs). The CCEs are grouped to form CCE aggregations. Four aggregation levels are defined: 1, 2, 4 and 8. A Downlink Control Information (DCI) is mapped to one of these CCE aggregation levels depending on its payload and the channel conditions. DCIs from different users are multiplexed in the PDCCH region, and higher aggregation levels present more protection to channel fluctuations than lower aggregation levels.

A DCI carries scheduling information for both uplink and downlink data traffic. Uplink data traffic includes data sent from a UE to a base station. Downlink data traffic includes data being sent from a base station to a UE. DCI provides a UE with information for proper reception and decoding of the downlink data transmission as well as encoding and transmission of the uplink transmission. There are four different DCI formats. DCI formats 0 and 3 are for uplink data transmissions, and DCI formats 1 and 2 are for downlink data transmission. A DCI carrying downlink scheduling information is called a DL assignment and a DCI carrying uplink scheduling information is called a UL grant. As used herein, DL assignment may be referred to as DL assignment DCI or DL DCI. UL grant may be referred to herein as UL grant DCI or UL DCI. One UE can have one or more DCIs in the same Transmission Time Interval (TTI).

Each DCI is carried on one or multiple Control Channel Elements (CCEs) depending on the DCI length and the channel condition. The number of CCEs used is referred to as the CCE aggregation level. All CCEs for the same DCI carry the same information. In case of multiple CCEs, i.e., higher aggregation level, the DCI payload is repeated, which achieves a lower code rate and which may be needed if the UE is experiencing poor radio conditions. Each CCE consists of 9 Resource Element Groups (REG). Each REG includes 4 (or 6 in the case of a Reference Symbol) consecutive Resource Elements (RE) in the frequency domain.

A DCI is mapped to a PDCCH at the physical layer (PHY). DCIs from multiple UEs are multiplexed together in the control symbol region, which are the first few OFDMA symbols, in a TTI. The payload of the DCI is rated, matched and scrambled with a cell-specific and a slot-specific scrambling sequence. Multiple REGs from the same CCE are interleaved and cyclic shifted (CS) among different frequency and time domains to achieve good frequency and time diversity. PDCCH occupies the first 1 to 3 or 4 symbols in each TTI depending on the bandwidth.

PDCCH link adaptation (LA) consist of dynamically selecting the aggregation level among 1, 2, 4 or 8 CCEs for each DCI according to the UE radio channel condition. The UE measures the channel conditions based on the received downlink signal and reports it to the eNB as a Channel Quality Indicator (CQI). The CQI is reported on Physical Uplink Control Channel (PUCCH) if the CQI report is periodic and on Physical Uplink Shared Channel (PUSCH) if the CQI report is aperiodic. A UE that is experiencing a very good channel condition and reporting a high CQI, will be signaled with the lowest CCE aggregation level which is 1. A UE experiencing very bad channel condition and reporting the lower CQI will be assigned the highest CCE aggregation level. The higher the aggregation level, the higher the signaling robustness.

The PDCCH resources are shared between UEs. Each scheduled UE is assigned a certain number of CCEs depending on its reported CQI and the adjustments decided by the outer loop. A maximum of 3 OFDM symbols per TTI are allocated for control channel, therefore, the number of CCEs available is limited. The total number of available CCEs is also a function of the bandwidth. Higher bandwidth systems have more CCEs and can handle more users.

Deciding about the CCE aggregation levels for each UE will impact the overall system capacity and performance. If the PDCCH Link Adaptation is conservative, higher aggregation levels are used. Consequently fewer UEs can be accommodated in each TTI but the PDCCH failure rate will be low due to usage of higher aggregation levels. If the PDCCH LA is aggressive, lower aggregation levels are used. In this case, the system capacity improves since more users can be accommodated but in detriment of the PDDCH failure rate. Consequently, throughput is also impacted since the UE may not able to detect the DL assignments and UL grants.

An outer loop is used to track the channel behavior and enhance the channel condition estimation. It makes use of the UE HARQ feedback and the PUSCH detection. If the HARQ feedback is ACK or NACK, the UE detection of the DL assignment is considered a success and consequently the outer loop is adjusted with an upward step, i.e., the outer loop adjustment is increased by a predetermined value when an ACK or NACK is received. But if the eNB does not detect any feedback on expected resource, the DL assignment is considered as lost and the outer loop is adjusted downward by a downward step, i.e., the outer loop adjustment is decreased by a predetermined value when no feedback is detected. Similarly, the UL grant is considered received by the UE if the eNB detects data on the UE related PUSCH. The outer loop is accordingly adjusted by the upward step. If the eNB fails to detect the data on the PUSCH, the UL grant is considered lost and the outer loop is adjusted by the downward step.

To accommodate systematic errors in CQI reporting from the UE and to track faster changes in channel conditions, a PDCCH outer loop adjustment is normally used to generate an outer loop adjustment, OL_ADJ, which is added to the PDCCH Signal to Interference plus Noise Ratio (SINR) estimation based on the CQI report. The overall estimated SINR based on the CQI report and the outer loop adjustment is used in determining the CCE aggregation level. The outer loop adjustment is calculated based on the PDCCH transmission result which is determined by eNB. The transmission result could be success, failure, or unknown.

In conventional methods, the outer loop is updated by fixed pre-determined upward and downward steps. If the HARQ feedback is an ACK or NACK, the outer loop is updated by the upward step. If a Discontinued Transmission (DTX) is detected, the outer loop is updated by the downward step. It requires several iterations for the outer loop to converge to an optimal operating point where an optimal CCE aggregation level is selected. The smaller the outer loop step sizes, the slower the convergence. In the absence of HARQ feedback, the link adaptation will be based solely on the CQI report which may be inaccurate or not timely reported. In addition, the channel may have changed since a last reported CQI, but the outer loop may not have been updated since the last HARQ feedback.

In case of carrier aggregation, many HARQ feedbacks are not considered for the PDCCH link adaptation. This is due to the ambiguity in the HARQ feedback that makes the eNB not able to determine if the UE has received the DL assignment or UL grant or not. For instance, if the UE does not detect the signaling on some carrier, it sets the corresponding HARQ response to NACK. The eNB is not able to know if it is UE sent a NACK or it is did not receive the DL Assignment or the UL grant.

Depending on the scheduling, the outer loop might not get any valid HARQ feedback for a relatively long time, and consequently, only the CQI report will be used for link adaptation. If the channel has changed since the last CQI and no valid HARQ feedback was received during that period, the optimal operating point for the PDCCH link adaptation may have moved far from the previous one.

The time between two consecutive valid channel events is called the Outer Loop Adjustment (OLA) “silence period”. Depending on the OLA silence period, the outer loop might require a high number of iterations to reach an optimal value when the pre-determined fixed upward and downward steps are used. If the new optimal operating point, where the outer loop should converge to produce optimal CCE aggregation level, is far from the previous optimal one, the intermediate selected aggregation levels can lead to unreliable signaling to the UE. The UE can be dropped before the OLA reaches the optimal operating point. It can also result in higher PDCCH load limiting the number of users that can accommodated simultaneously.

### SUMMARY

The present invention relates to an outer loop adjustment for wireless communication link adaptation. In accordance with one embodiment of the present invention, a method of adjusting an outer loop for link adaptation of a physical downlink control channel, PDCCH, in a communication network to establish a control channel element, CCE aggregation level includes determining, by a base station, a period of time between receipt of two consecutive channel events from a user equipment, UE. At least one of an upward step and a downward step of an outer loop adjustment is adjusted based on the determined period of time. The adjusted at least one of the upward step size and downward step size affects the outer loop adjustment for link adaptation of the PDCCH.

In accordance with an aspect of this embodiment, adjusting the at least one of the upward step size and the downward step size includes factoring the at least one upward step size and downward step size by an adjustment factor determined based on the period of time between the two consecutive channel events. The adjustment factor is between 1 and a maximum value. The outer loop adjustment is updated by the upward step if a channel event is received and by the downward step if a Discontinued Transmission, DTX, is detected.

In accordance with another aspect of this embodiment, the adjustment factor is determined by the formula F(t)=1+b*(1−â(t−t₀)), where, F(t) is the adjustment factor determined at time t, b is a parameter determining the maximum value of the adjustment factor, a is a parameter between 0 and 1, and t₀ is a maximum allowed silence period with no step size adjustment, the silence period being a period of time between two consecutive channel events.

In accordance with yet another aspect of this embodiment, the adjustment factor is determined by the formula F(t)=b*(t−t₀)/(tₑ−t₀)+1, where, F(t) is the adjustment factor determined at time t, b is a parameter determining the maximum value of the adjustment factor, t₀ is a maximum allowed silence period with no step size adjustment, the silence period being a period of time between two consecutive channel events, and t₀ is a predetermined silence period for the adjustment factor to reach the maximum value 1+b.

In accordance with still another aspect of this embodiment, the adjustment factor approaches the maximum value as the period of time between the two consecutive channel events increases above a threshold value, the adjustment factor one of asymptotically approaching the maximum value and proportionally approaching the maximum value.

In accordance with an aspect of this embodiment, a status of one of a downlink assignment and an uplink grant is determined. The outer loop adjustment is updated based on the status of the at least one of the downlink assignment and the uplink grant.

In accordance with another aspect of this embodiment, determining the status of the one of the downlink assignment and the uplink grant includes receiving one of an acknowledgement, ACK, and a not-acknowledgment, NACK, for a downlink data packet corresponding to the downlink assignment, and receiving an uplink data packet corresponding to the uplink grant.

In accordance with still another aspect of this embodiment, determining the period of time between two consecutive channel events includes receiving, at a first time, one of a first Hybrid Automatic Repeat Request, HARQ, message corresponding to one of a first downlink assignment and a first uplink grant, and a first uplink data packet corresponding to the first uplink grant. At a second time, one of a second HARQ message corresponding to one of a second downlink assignment and a second uplink grant, and a second uplink data packet corresponding to the second uplink grant is received. A difference between the first time and the second time is determined.

In accordance with one embodiment of the present invention, a base station is provided for communication with a user equipment, UE. The base station is configured to perform an outer loop adjustment for link adaptation of a physical downlink control channel, PDCCH, in a communication network to establish a control channel element, CCE, aggregation level. The base station includes a processor in communication with the receiver. The processor is configured to determine a period of time between receipt of two consecutive channel events from the UE, and adjust at least one of an upward step and a downward step of an outer loop adjustment based on the determined period of time, the adjusted at least one of the upward step size and downward step size affecting the outer loop adjustment for link adaptation of the PDCCH.

In accordance with an aspect of this embodiment, the processor is configured to adjust the at least one of the upward step and the downward step of the outer loop adjustment by factoring the at least one of the upward step and the downward step by an adjustment factor, the adjustment factor being based on the determined period of time between the two consecutive channel events, the adjustment factor being between 1 and a maximum value. The processor is further configured to update the outer loop adjustment by the upward step if the a channel event is received, and update the outer loop adjustment by the downward step if a Discontinued Transmission, DTX, is detected.

In accordance with another aspect of this embodiment, the adjustment factor is determined by the formula F(t)=1+b*(1−â(t−t₀)), where F(t) is the adjustment factor determined at time t, b is a parameter determining the maximum value of the adjustment factor, a is a parameter between 0 and 1, and t₀ is a maximum allowed silence period with no step size adjustment, the silence period being a period of time between two consecutive channel events.

In accordance with still another aspect of this embodiment, the adjustment factor is determined by the formula F(t)=b*(t−t₀)/(tₑ−t₀)+1, where F(t) is the adjustment factor determined at time t, b is a parameter determining the maximum value of the adjustment factor, t₀ is a maximum allowed silence period with no step size adjustment, the silence period being a period of time between two consecutive channel events, and to is a predetermined silence period for the adjustment factor to reach the maximum value 1+b.

In accordance with yet another aspect of this embodiment, the adjustment factor asymptotically approaches the maximum value as the period of time between the two consecutive channel events increases above a threshold value, the adjustment factor one of asymptotically approaching the maximum value and proportionally approaching the maximum value.

In accordance with an aspect of this embodiment, the processor is further configured to determine a status of one of a downlink assignment and an uplink grant, and update the outer loop adjustment based on the status of the at last one of the downlink assignment and the uplink grant.

In accordance with another aspect of this embodiment, the processor is configured to determine the status of the one of the one of the downlink assignment and the uplink grant by receiving one of an acknowledgment, ACK, and a not-acknowledgment, NACK, for a downlink data packet corresponding to the downlink assignment, and receiving an uplink data packet corresponding to the uplink grant.

In accordance with still another aspect of this embodiment, the processor is configured to determine the period of time between two consecutive channel events by receiving, at a first time, one of a first Hybrid Automatic Repeat Request, HARQ, message corresponding to one of a first downlink assignment and a first uplink grant, and a first uplink data packet corresponding to the first uplink grant. At a second time, one of a second HARQ message corresponding to one of a second downlink assignment and a second uplink grant, and a second uplink data packet corresponding to the second uplink grant is received. A difference between the first time and the second time is determined.

In accordance with one embodiment of the present invention, a method of adjusting an outer loop for link adaptation of a physical downlink shared channel, PDSCH, in a communication network for a base station communicating with a user equipment, UE, is provided. The method includes determining, by the base station, a period of time between receipt of two consecutive downlink feedback messages, each feedback message being one of an Acknowledgement, ACK, and a Not-Acknowledgment, NACK, from the UE. At least one of an upward step size and a downward step size of an outer loop adjustment is adjusted based on the determined period of time between the two consecutive downlink feedback messages, the adapted at least one of the upward step size and downward step size affecting the outer loop adjustment for link adaptation of the PDSCH.

In accordance with an aspect of this embodiment, the at least one of the upward step size and downward step size is factored by an adjustment factor. The adjustment factor is determined based on the period of time between two consecutive downlink feedbacks.

In accordance with another aspect of this embodiment, the adjustment factor is determined by the formula, F(t)=1+b*(1−â(t−t₀)), where F(t) is the adjustment factor determined at time t, b is a parameter defining the maximum value of the adjustment factor, a is a parameter between 0 and 1, and t₀ is a maximum allowed silence period with no step size adjustment, the silence period being a period of time between two consecutive downlink feedback messages.

In accordance with still another aspect of this embodiment, the adjustment factor is determined by the formula: F(t)=b*(t−t₀)/(tₑ−t₀)+1, where F(t) is the adjustment factor determined at time t, b is a parameter determining the maximum value of the adjustment factor, to is a maximum allowed silence period with no step size adjustment, the silence period being a period of time between two consecutive downlink feedback messages, and t₀ is a predetermined silence period for the adjustment factor to reach the maximum value 1+b.

In accordance with yet another aspect of this embodiment, the adjustment factor is between 1 and a maximum value, and the adjustment factor one of asymptotically approaches and proportionally approaches the maximum value as the period of time between the two consecutive downlink feedbacks increases above a threshold value.

In accordance with an aspect of this embodiment, determining the period of time between two consecutive downlink feedbacks includes receiving, at a first time, a first downlink feedback corresponding to a first downlink data packet. At a second time, a second downlink feedback corresponding to a second downlink data packet is received, and a difference between the first time and the second time is determined

In accordance with one embodiment of the present invention, a node for communicating with a user equipment, UE, is provided. The node is configured to perform an outer loop adjustment for link adaptation of a physical downlink control channel, PDCCH, in a communication network to establish a control channel element, CCE, aggregation level. The node includes a determination module for determining a period of time between receipt of two consecutive channel events from a user equipment, UE. The node further includes an adjustment module for adjusting at least one of an upward step and a downward step of an outer loop adjustment based on the determined period of time between the two consecutive channel events, the adjusted at least one of the upward step size and downward step size affecting the outer loop adjustment for link adaptation of the PDCCH.

In accordance with another embodiment of the present invention, a node for communicating with a user equipment, UE, is provided. The node is configured to perform an outer loop adjustment for link adaptation of a physical downlink shared channel, PDSCH, in a communication network. The node includes a determination module for determining a period of time between receipt of two consecutive downlink feedback messages, each feedback message being one of an Acknowledgment, ACK and a Not-Acknowledgement, NACK, from the UE. The node further includes an adjustment module for adjusting at least one of an upward step size and a downward step size of an outer loop adjustment based on the determined period of time between the two consecutive downlink feedback messages, the adapted at least one of the upward step size and downward step size affecting the outer loop adjustment for link adaptation of the PDSCH.

### BRIEF DESCRIPTION OF THE DRAWINGS

FIG. 1 is a block diagram of a communications system constructed in accordance with principles of the present invention;

FIG. 2 is block diagram of an exemplary system for updating an outer loop adjustment using an outer loop adjustment module in accordance with principles of the present invention;

FIG. 3 is a flow chart of an exemplary process for performing an outer loop adjustment in accordance with principles of the present invention;

FIG. 4 is a flow chart of an exemplary process for adjusting outer loop parameters in accordance with principles of the present invention;

FIG. 5 is a flow chart of an exemplary process for updating an outer loop adjustment step size in accordance with principles of the present invention;

FIG. 6 is a flow chart of an exemplary process for determining a period of time between consecutive channel events in accordance with principles of the present invention;

FIG. 7 is a flow chart of an exemplary process for adjusting the upward step or the downward step in accordance with principles of the present invention;

FIG. 8 is a flow chart of an exemplary process for receiving a channel event, in accordance with principles of the present invention;

FIG. 9 is a graph of an exemplary adjustment factor; and

FIG. 10 is another graph of an exemplary adjustment factor.

### DETAILED DESCRIPTION

In order to reduce convergence time of an outer loop adjustment of a Downlink Control Information (DCI) Control Channel Element (CCE) in a Physical Downlink Control Channel (PDCCH) there is a relatively long period of time between channel events i.e., an outer loop adjustment “silence period,” it may be advantageous to vary an upward and downward step size of the outer loop adjustment based on the silence period.

As used herein, relational terms, such as “first” and “second,” “top” and “bottom,” and the like, may be used solely to distinguish one entity or element from another entity or element without necessarily requiring or implying any physical or logical relationship or order between such entities or elements.

In embodiments described herein, the joining term, “in communication with” and “connected to,” and the like, may be used to indicate electrical or data communication, which may be accomplished by physical contact, induction, electromagnetic radiation, radio signaling, infrared signaling or optical signaling, for example. The above methods of achieving electrical or data communication are non-limiting and mentioned only for illustration. One having ordinary skill in the art will appreciate that multiple components may interoperate and modifications and variations are possible of achieving the electrical and data communication.

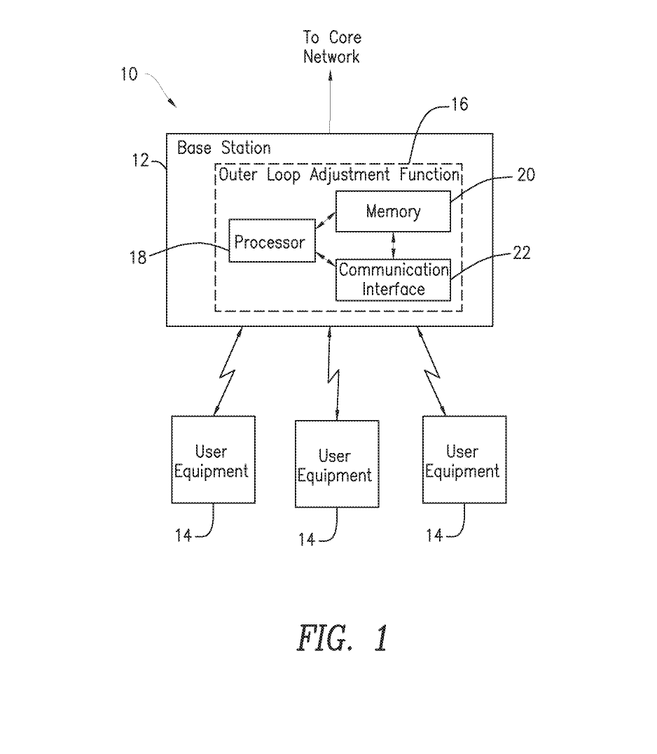

Referring to the drawing figures in which like reference designators refer to like elements, FIG. 1 shows a block diagram of a communication system 10 according to an exemplary embodiment of the present invention. In one exemplary embodiment, communication system 10 is a Long Term Evolution (LTE) network, however, the invention is not limited to such. It is contemplated that other networking technologies, such as other network types compliant with 3rd Generation Partnership Project (3GPP) specifications can be implemented as communication system 10. The communication system 10 includes a base station 12 in communication with one or more user equipments (UE) 14. The base station 12 may be part of a Radio Access Network (RAN) (not pictured) that is in communication with a Core Network (CN) (not pictured) and may be, for example, an Evolved Node B (eNodeB), which may be in communication with a core network in an LTE network. The base station provides the air interface for the UE 14 and communicatively couples the UE to a CN, for example. The base station 12 includes an outer loop adjustment function 16 for controlling adaptation of the wireless communication link between the base station 12 and the UE 14.

The outer loop adjustment function 16 may be implemented, for example, in hardware on a processor 18 or as a combination of hardware and software. Programmatic code to implement aspects of the outer loop adjustment function 16, including the functions of the processor 18 can be stored in a memory 20. The memory 20 may be any volatile or non-volatile storage device capable of storing data including, for example, solid-state memory, optical storage and magnetic storage. The outer loop adjustment function 16 may utilize a communication interface 22 to determine characteristics of the communication link, such as the channel quality between the base station 12 and the UE 14. The communication interface 22 may also be used for data communication between the base station 12 and the UE 14.

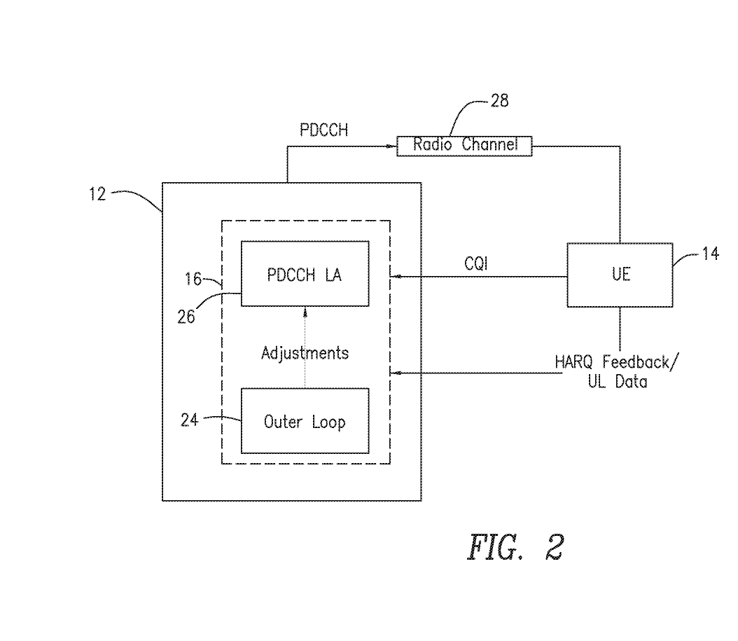

An exemplary block diagram of a system for performing an outer loop adjustment using an outer loop adjustment function in accordance with principles of the present invention is described with reference to FIG. 2. An outer loop adjustment module 24 is shown. The outer loop adjustment module 24 performs an outer loop adjustment of a Physical Downlink Control Channel (PDCCH) link adaptation value, which is used by a link adaptation module 26 to determine a Control Channel Element (CCEs) aggregation level on a the Physical Downlink Control Channel (PDCCH) of a radio channel 28 between the base station 12 and the UE 14. The outer loop adjustment module 24 is configured to detect channel events including when (1) feedback is received for a downlink assignment downlink control information (DL DCI) and a data packet is received for an uplink grant downlink control information (UL DCI), (2)feedback is only received for a DL DCI, or (3) only a data packet is received for a UL DCI from the UE 14. It will be recognized that detection of channel events is not limited to detection on the PDCCH, but also detection on the Physical Uplink Shared Channel (PUSCH) and the Physical Uplink Control Channel (PUCCH). The channel events include events related to a PDCCH transmission, e.g., a DL DCI or a UL DCI, that are detected on the PUSCH and/or the PUCCH. According to some exemplary embodiments, a channel event is a response to one of a UL DCI or a DL DCI, and includes, for example, a Hybrid Automatic Repeat Request (HARQ) feedback message, an uplink data packet, an acknowledgement (ACK) or a non-acknowledgement (NACK). As used herein, a channel event may also include detection of a Discontinued Transmission (DTX) event. When a channel event is received, a time between consecutive channel events is determined The determined time between the consecutive channel events is used to determine a factor that adjusts the outer loop downward step value and the outer loop upward step value, collectively referred to as the outer loop adjustment parameters.

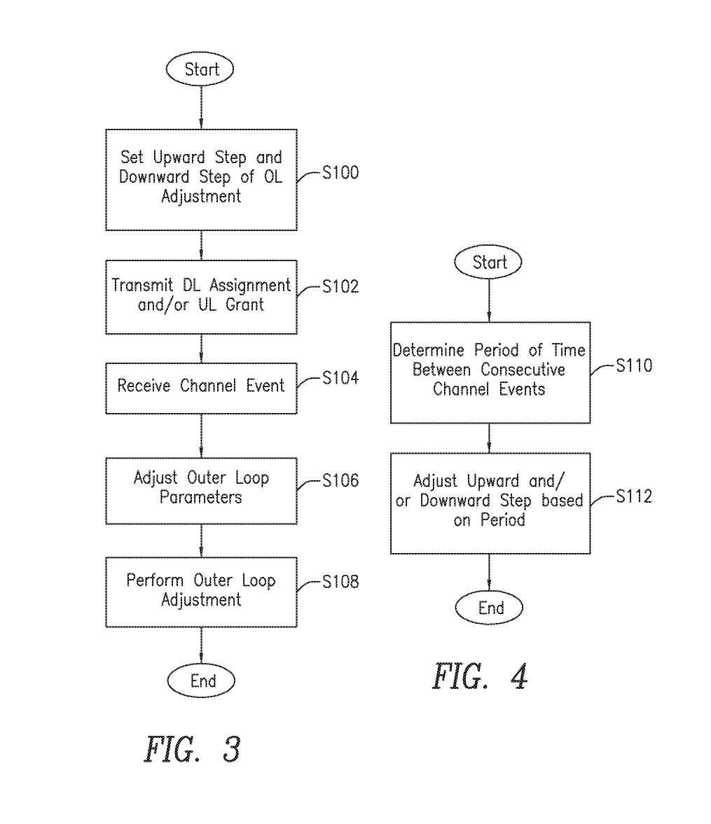

A block diagram of an exemplary process of performing an outer loop adjustment is described with reference to FIG. 3. The outer loop adjustment module 24 sets an initial value for the outer loop downward step value and the outer loop upward step value (block S100). According to some exemplary embodiments, the initial values above may be set based on a desired Block Error Rate (BLER) for the channel. The base station 12 transmits a UL DCI or a DL DCI on the radio channel 28 to the UE 14 (block S102). The link adaptation module 26 receives a channel event (block S104) and based on a period of time between the received channel event and a previously received channel event, the outer loop adjustment function 16 adjusts at least one of the outer loop downward step value and the outer loop upward step value (block S106). Using the adjusted outer loop adjustment parameters, the outer loop adjustment module 24 performs an adjustment, i.e., an outer loop adjustment, of the PDCCH link adaptation value (block S108).

An exemplary block diagram of a process of adjusting the outer loop adjustment parameters is shown with reference to FIG. 4. The link adaptation module 26 receives multiple channel events and determines a period of time between two consecutive channel events (block S110). According to some exemplary embodiments, the link adaptation module 26 may determine the period of time between the two most recently received consecutive channel events. According to other exemplary embodiments, the link adaptation module 26 determines the period of time between consecutive channel events as a calculated average between two consecutive channel events, e.g., a moving average, weighted moving average, exponential moving average, and the like. The outer loop adjustment module 24 adjusts the outer loop downward step value and the outer loop upward step value based on the determined period between channel events (block S112).

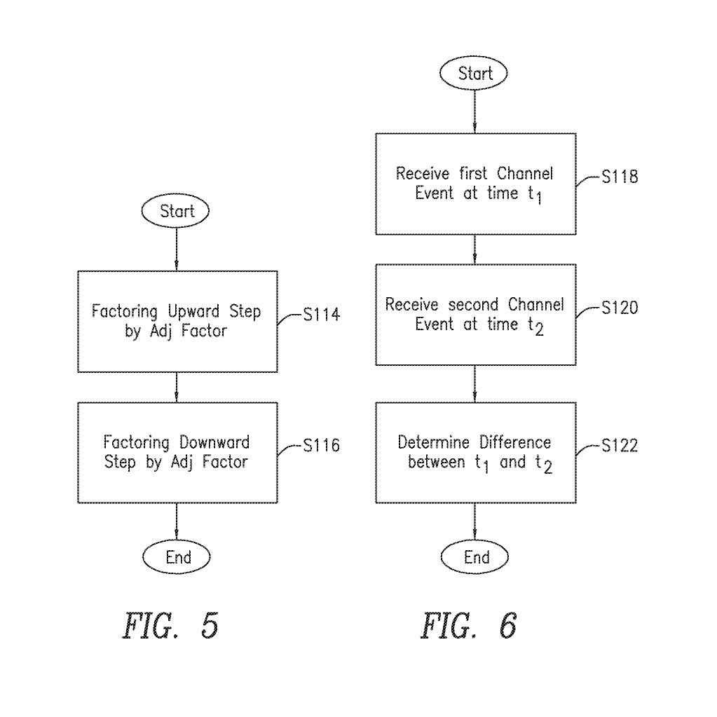

FIG. 5 shows an exemplary block diagram of a process of adjusting the outer loop downward step value and the outer loop upward step value. The outer loop adjustment module 24 multiplies the initial outer loop upward step size by an adjustment factor that is based on the period of time between consecutive channel events (block S114). The outer loop adjustment module 24 multiplies the initial outer loop downward step size by the adjustment factor (block S116). The adjustment factor, F, is calculated by the following formula:

F(t)=1+b*(1−â(t−t₀)), (Eq. 1) where

F(t) is the adjustment factor for a period of time between channel events, t;

b is a positive parameter determining a maximum value of the adjustment factor;

a is a parameter between 0 and 1; and

t₀ is a maximum allowed period of time with no step size adjustment between consecutive channel events, i.e., no adjustment of the outer loop downward step value or the outer loop upward step value. The period of time between consecutive channel events may be referred to herein as a silence period. Eq. 1 is valid for t>=t₀. For t<t₀, F(t)=1. Thus, the adjustment factor F varies between 1 and a maximum value 1+b based on the silence period t. In particular, Eq. 1 shows that the adjustment factor F asymptotically approaches the maximum value 1+b as t approaches infinity.

According to some exemplary embodiments the adjustment factor F(t)=1+b, when t>tₘₐₓ, for simplicity of calculation where tₘₐₓ is a predetermined maximum silence period.

According to some exemplary embodiments, the adjustment factor may be calculated by the following formula:

F(t)=b*(t−t₀)/(tₑ−t₀)+1, (Eq. 2) where

F(t) is the adjustment factor for a silence period, t;

b is the positive parameter determining the maximum value of the adjustment factor;

t₀ is the maximum allowed silence period with no step size adjustment; and

tₑ is a predetermined silence period for the adjustment factor to reach the maximum value of b+1. Eq. 2 is valid for t₀<=t<=tₑ. For t<t₀, F(t)=1; and for t>tₑ, F(t)=1+b. Thus, the adjustment factor F varies between 1 and a maximum value 1+b based on the silence period t. In particular, Eq. 2 shows that the adjustment factor F linearly, or proportionally, approaches the maximum value 1+b as t increases above the maximum allowed silence period with no step size adjustment to and approaches the predetermined value tₑ. The adjustment factor F is equal to the maximum value 1+b for t greater than tₑ.

It will be appreciated that, in the above formulas, the adjustment factor, F(t), approaches the maximum value of 1+b as the silence period, t, increases in both Eqs. 1 and 2 above. It will be further appreciated that the variables b, t₀, and tₑ above may be selected based on a desired convergence speed of the PDCCH link adaptation value.

A process of determining a period of time between successive channel events is described with reference to FIG. 6. The link adaptation module 26 receives a first channel event at a first time t₁ (block S118). The link adaptation module 26 receives a second channel event a second time t₂ (block S120). The outer loop adjustment module 24 determines a difference between the first time t₁ and the second time t₂ by subtracting t₁ from t₂ (block S122).

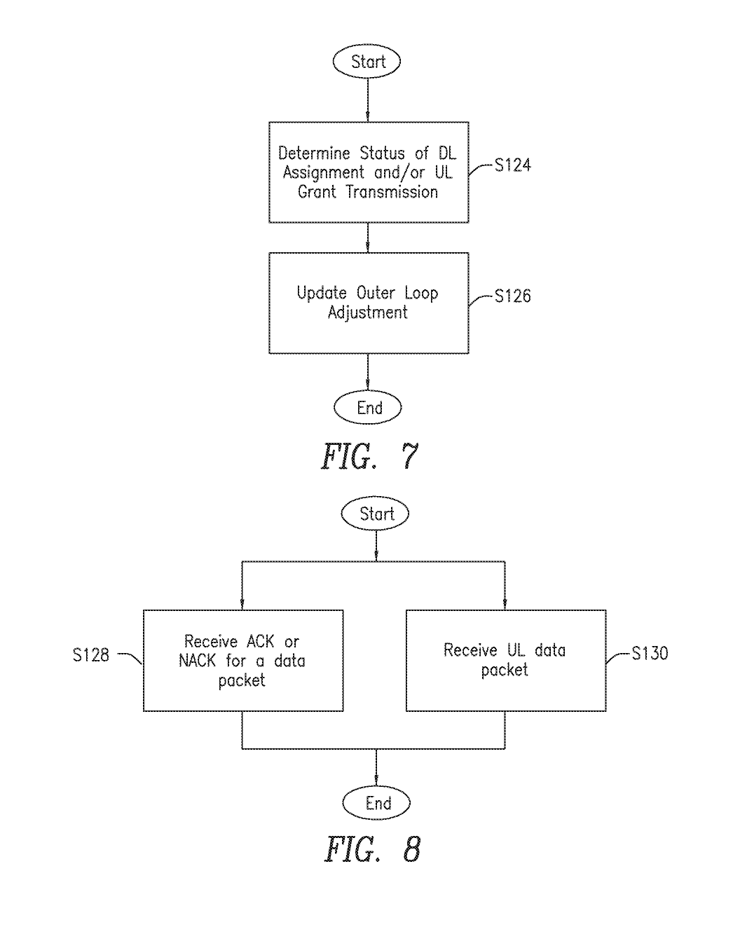

A process of performing the outer loop adjustment of the PDCCH link adaptation value is described with reference to FIG. 7. The outer loop adjustment module 24 determines a status of the downlink assignment DCI or the uplink grant DCI (block S124). The outer loop adjustment module 24 updates the PDCCH link adaptation value based on the determined status (block S126). The determined status of the downlink assignment DCI or the uplink grant DCI is one of successful or unsuccessful, and is indirectly determined based on a response to a downlink packet corresponding to the downlink assignment DCI or receipt of an uplink packet corresponding to the uplink grant DCI.

A process for receiving a channel event is described with reference to FIG. 8.

According to some exemplary embodiments, the status of a DL DCI is determined by receiving an Acknowledgment, ACK, message or a Not-Acknowledgment, NACK, message in response to a transmitted downlink data packet that corresponds to the DL DCI (block S128). According to some exemplary embodiments, the status of the UL DCI is determined by receiving a received uplink data packet that corresponds to the UL DCI (block S130). Receiving an ACK, NACK, or an uplink data packet is considered a successful DL DCI or UL DCI. According to some exemplary embodiments, the status is determined by receiving a Discontinued Transmission (DTX) condition. The DTX condition is considered an unsuccessful DL DCI or UL DCI.

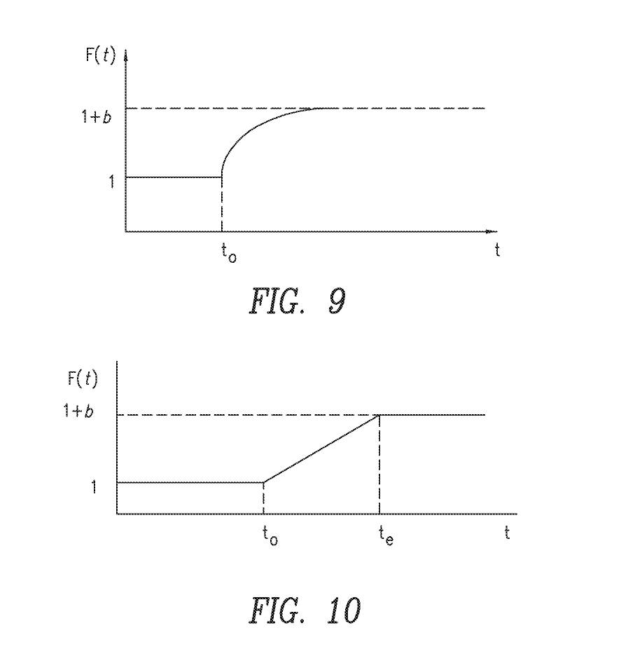

A graph showing a relationship between the silence period, t, and the adjustment factor F will be described for Eq. 1 above with reference to FIG. 9. For 0<t<t₀, F(t)=1. For t>=t₀, F(t)=1+b*(1−â(t−t₀)), such that F asymptotically approaches 1+b as the silence period, t, increases.

A graph showing a relationship between the silence period, t, and the adjustment factor F will be described for Eq. 2 above with reference to FIG. 10. For t<t₀, F(t)=1. For t₀<=t<=tₑ, F(t)=b*(t−t₀)/(tₑ−t₀)+1, such that F proportionally approaches 1+b with a slope of b/(tₑ−t₀). For t>tₑ, F(t)=1+b.

Thus, as described above with regard to FIGS. 9 and 10, the adjustment factor F varies between 1 and the maximum value 1+b based on the silence period t. As shown in FIG. 9, F asymptotically approaches 1+b when t is greater than t₀. As shown in FIG. 10, F approaches 1+b in a linear or proportional fashion when t is greater than t₀. As described above with regard to FIG. 5, the downward step size and upward step size are factored by the adjustment factor F. Because the adjustment factor F may vary between 1 and the maximum value 1+b, the factored downward step size and upward step size may, therefore, be greater than their corresponding predetermined values. When the downward step size and upward step size are greater than their corresponding predetermined values, the outer loop adjustment uses greater step sizes (both upward and downward) to converge on the PDCCH link adaptation value.

Thus, by using a downward step size and upward step size that is factored by the adjustment factor as described above, faster convergence of the PDCCH link adaptation value is achieved especially, for example, in a case having a relatively longer time between channel events, as compared to conventional PDCCH link adaptation where the downward step size and the upward step size are fixed regardless of the silence period. Moreover, convergence speed for the PDCCH link adaptation value is tunable by adjusting the parameters used to determine the adjustment factor as described above.

Each of the process steps described in FIGS. 3-8 above may each be individually implemented or collectively implemented in a corresponding module that includes, for example, hardware on a processor or a combination of hardware and software. For example, with reference to FIG. 4, a determining module may be configured to determine the period of time between receipt of two consecutive channel events as shown in block S110. Moreover an adjustment module may be configured to adjust at least one of an upward step value and a downward step value based on the determined period between channel events as shown in block S112.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

1. A method of adjusting an outer loop for link adaptation of a physical downlink control channel, PDCCH, in a communication network to establish a control channel element, CCE, aggregation level, the method comprising:
determining, by a base station a period of time between receipt of two consecutive channel events from a user equipment, UE; and
adjusting at least one of an upward step and a downward step of an outer loop adjustment based on the determined period of time, the adjusted at least one of the upward step size and downward step size affecting the outer loop adjustment for link adaptation of the PDCCH.

2. The method according to claim 1, wherein the adjusting the at least one of the upward step size and the downward step size comprises:
factoring the at least one upward step size and downward step size by an adjustment factor determined based on the period of time between the two consecutive channel events, the adjustment factor being between 1 and a maximum value; and
the method further comprises:
updating the outer loop adjustment by the upward step if a channel event is received; and
updating the outer loop adjustment by the downward step if a Discontinued Transmission, DTX, is detected.

3. The method according to claim 2, wherein the adjustment factor is determined by the formula, F(t)=1+b*(1−â(t−t₀)), wherein:
F(t) is the adjustment factor determined at time t;
b is a parameter determining the maximum value of the adjustment factor;
a is a parameter between 0 and 1; and
t₀ is a maximum allowed silence period with no step size adjustment, the silence period being a period of time between two consecutive channel events.

4. The method according to claim 2, wherein the adjustment factor is determined by the formula: F(t)=b*(t−t₀)/(tₑ−t₀)+1, wherein:
F(t) is the adjustment factor determined at time t;
b is a parameter determining the maximum value of the adjustment factor;
t₀ is a maximum allowed silence period with no step size adjustment, the silence period being a period of time between two consecutive channel events; and
tₑ is a predetermined silence period for the adjustment factor to reach the maximum value 1+b.

5. The method according to claim 2, wherein:
the adjustment factor approaches the maximum value as the period of time between the two consecutive channel events increases above a threshold value, the adjustment factor one of asymptotically approaching the maximum value and proportionally approaching the maximum value.

6. The method according to claim 1, further comprising:
determining a status of one of a downlink assignment and an uplink grant; and
updating the outer loop adjustment based on the status of the at least one of the downlink assignment and the uplink grant.

7. The method according to claim 6, wherein determining the status of the one of the downlink assignment and the uplink grant comprises:
receiving one of an acknowledgement, ACK, and a not-acknowledgment, NACK, for a downlink data packet corresponding to the downlink assignment; and
receiving an uplink data packet corresponding to the uplink grant.

8. The method according to claim 1, wherein determining the period of time between two consecutive channel events comprises:
receiving, at a first time, one of a first Hybrid Automatic Repeat Request, HARQ, message corresponding to one of a first downlink assignment and a first uplink grant, and a first uplink data packet corresponding to the first uplink grant;
receiving, at a second time, one of a second HARQ message corresponding to one of a second downlink assignment and a second uplink grant, and a second uplink data packet corresponding to the second uplink grant; and
determining a difference between the first time and the second time.

9. A base station for communication with a user equipment, UE, the base station configured to perform an outer loop adjustment for link adaptation of a physical downlink control channel, PDCCH, in a communication network to establish a control channel element, CCE, aggregation level, the base station comprising:
a processor in communication with the receiver, the processor configured to:
determine a period of time between receipt of two consecutive channel events from the UE; and
adjust at least one of an upward step and a downward step of an outer loop adjustment based on the determined period of time, the adjusted at least one of the upward step size and downward step size affecting the outer loop adjustment for link adaptation of the PDCCH.

10. The base station according to claim 9, wherein the processor is configured to adjust the at least one of the upward step and the downward step of the outer loop adjustment by:
factoring the at least one of the upward step and the downward step by an adjustment factor, the adjustment factor being based on the determined period of time between the two consecutive channel events, the adjustment factor being between 1 and a maximum value; and
the processor is further configured to:
update the outer loop adjustment by the upward step if the a channel event is received; and
update the outer loop adjustment by the downward step if a Discontinued Transmission, DTX, is detected.

11. The base station according to claim 10, wherein the adjustment factor is determined by the formula, F(t)=1+b*(1−â(t−t₀)), wherein:
F(t) is the adjustment factor determined at time t;
b is a parameter determining the maximum value of the adjustment factor;
a is a parameter between 0 and 1; and
t₀ is a maximum allowed silence period with no step size adjustment, the silence period being a period of time between two consecutive channel events.

12. The base station according to claim 10, wherein the adjustment factor is determined by the formula: F(t)=b*(t−t₀)/(tₑ−t₀)+1, wherein:
F(t) is the adjustment factor determined at time t;
b is a parameter determining the maximum value of the adjustment factor;
t₀ is a maximum allowed silence period with no step size adjustment, the silence period being a period of time between two consecutive channel events; and
tₑ is a predetermined silence period for the adjustment factor to reach the maximum value 1+b.

13. The base station according to claim 10, wherein:
the adjustment factor asymptotically approaches the maximum value as the period of time between the two consecutive channel events increases above a threshold value, the adjustment factor one of asymptotically approaching the maximum value and proportionally approaching the maximum value.

14. The base station according to claim 9, the processor further configured to:
determine a status of one of a downlink assignment and an uplink grant; and
update the outer loop adjustment based on the status of the at last one of the downlink assignment and the uplink grant.

15. The base station according to claim 14, wherein the processor is configured to determine the status of the one of the one of the downlink assignment and the uplink grant by:
receiving one of an acknowledgment, ACK, and a not-acknowledgment, NACK, for a downlink data packet corresponding to the downlink assignment; and
receiving an uplink data packet corresponding to the uplink grant.

16. The base station according to claim 9, wherein the processor is configured to determine the period of time between two consecutive channel events by;
receiving, at a first time, one of a first Hybrid Automatic Repeat Request, HARQ, message corresponding to one of a first downlink assignment and a first uplink grant, and a first uplink data packet corresponding to the first uplink grant;
receiving, at a second time, one of a second HARQ message corresponding to one of a second downlink assignment and a second uplink grant, and a second uplink data packet corresponding to the second uplink grant; and
determining a difference between the first time and the second time.

17. A method of adjusting an outer loop for link adaptation of a physical downlink shared channel, PDSCH, in a communication network (for a base station communicating with a user equipment, UE, the method comprising:
determining, by the base station, a period of time between receipt of two consecutive downlink feedback messages, each feedback message being one of an Acknowledgement, ACK, and a Not-Acknowledgment, NACK, from the UE; and
adjusting at least one of an upward step size and a down d step size of an outer loop adjustment based on the determined period of time between the two consecutive downlink feedback messages, the adapted at least one of the upward step size and downward step size affecting the outer loop adjustment for link adaptation of the PDSCH.

18. The method according to claim 17, further comprising:
factoring the at least one of the upward step size and downward step size by an adjustment factor, the adjustment factor being determined based on the period of time between two consecutive downlink feedbacks.

19. The method according to claim 18, wherein the adjustment factor is determined by the formula, F(t)=1+b*(1−â(t−t₀)), wherein:
F(t) is the adjustment factor determined at time t;
b is a parameter defining the maximum value of the adjustment factor;
a is a parameter between 0 and 1; and
t₀ is a maximum allowed silence period with no step size adjustment, the silence period being a period of time between two consecutive downlink feedback messages.

20. The method according to claim 18, wherein the adjustment factor is determined by the formula: F(t)=b*(t−t₀)/(tₑ−t₀)+1, wherein:
F(t) is the adjustment factor determined at time t;
b is a parameter determining the maximum value of the adjustment factor;
t₀ is a maximum allowed silence period with no step size adjustment, the silence period being a period of time between two consecutive downlink feedback messages; and
tₑ is a predetermined silence period for the adjustment factor to reach the maximum value 1+b.

21. The method according to claim 18, wherein:
the adjustment factor is between 1 and a maximum value; and
the adjustment factor one of asymptotically approaches and proportionally approaches the maximum value as the period of time between the two consecutive downlink feedbacks increases above a threshold value.

22. The method according to claim 17, wherein determining the period of time between two consecutive downlink feedbacks comprises:
receiving, at a first time, a first downlink feedback corresponding to a first downlink data packet;
receiving, at a second time, a second downlink feedback corresponding to a second downlink data packet; and
determining a difference between the first time and the second time.

23-24. (canceled)
